(19) United States
(12) Patent Application Publication
(10) Pub. No.: US 2024/0265055 A1
(43) Pub. Date: Aug. 8, 2024

(54) CONTENT RECOMMENDATION SYSTEM

(71) Applicant: The Toronto Dominion Bank, Toronto (CA)

(72) Inventor: SAGAR NEEL PURKAYASTHA, Calgary (CA)

(21) Appl. No.: 18/163,358

(22) Filed: Feb. 2, 2023

(51) Int. Cl. G06F 16/954; H04L 67/50

(52) U.S. Cl. CPC G06F 16/954; H04L 67/535

(57) ABSTRACT

One example method includes determining, based on user activity data, that a first user of a first platform has not interacted with content of a content platform during a particular timeframe. First attribute data corresponding to the first user can be obtained from a user account repository stored on the first platform. The first attribute data can be input into a trained model. The trained model is trained using attribute data for a plurality of users of the first platform and corresponding content preference data for the plurality of users. Data identifying a set of users of the first platform who are expected to have similar content preferences as the first user can be obtained using an output generated by the trained model in response to the input first attribute data. A list of content items can be generated using content with which the set of users has interacted, a list of content items. The list of content items can be provided for display in a user interface of the content platform.

### TECHNICAL FIELD

The present disclosure relates to computer-implemented methods, software, and systems for recommending content items to users of a content platform.

### BACKGROUND

A content platform that provides content items to users should provide an engaging and interesting experience for its users in order to retain users. One way to provide an engaging and interesting experience is to customize each user's experience, for example, by providing content items that reflect their interests.

Conventional recommendation systems for a content platform generally make content recommendations for a particular user based on the user's previous interactions with the content platform. However, in some instances, the user may not have previously interacted with or otherwise consumed content items (which are also referred to herein as digital components) on the content platform. In such instances, the content items that are recommended and provided to the user may be generically sourced. For example, the system may provide popular or trending content on the content platform to the user. However, the generically sourced content items may not garner any interactions (e.g., content selection and viewing) from the particular user because the attributes and/or subject matter of the content does not align with the user's interests or viewing preferences. In some instances, the user may have some previous interactions with content items on the content platform, but not enough previous interactions for a conventional recommendation system to provide content in which the user may actually be interested.

### SUMMARY

The present disclosure generally relates to systems, software, and computer-implemented methods for recommending content items to users of a content platform. As used in this specification, a content item represents digital content that a user can interact with and/or consume on a user device. Examples of content items include, among others, news articles, blog posts, images, etc. that are provided for display on a client device (e.g., within a web browser or other application that displays web pages).

A first example method includes determining, based on user activity data, that a first user of a first platform has not interacted with content of a content platform during a particular timeframe. First attribute data corresponding to the first user can be obtained from a user account repository stored on the first platform. The first attribute data can be input into a trained model. The trained model is trained using attribute data for a plurality of users of the first platform and corresponding content preference data for the plurality of users. Data identifying a set of users of the first platform who are expected to have similar content preferences as the first user can be obtained using an output generated by the trained model in response to the input first attribute data. A list of content items can be generated using content with which the set of users has interacted, a list of content items. The list of content items can be provided for display in a user interface of the content platform.

Implementations can optionally include one or more of the following features.

In some implementations, the trained model is a tree-based model with a linear regressor.

In some implementations, the first attribute data includes data for a plurality of attributes, including login history for the first user at the first platform, age of an account of the first user at the first platform, and types of investments held in the account of the first user.

In some implementations, the data identifying a set of users of the first platform who are expected to have similar content preferences as the first user includes a list of users of the first platform and corresponding scores representing a degree of similarity of content preferences between the first user and each respective user in the list of users; and the first example method further includes selecting, based on the scores, the set of users from among the users listed in the list of users.

In some implementations, generating, using content with which the set of users has interacted, the list of content items, includes: identifying content items with which each user in the set of users has interacted; and generating the list of content items from among the identified content items based on a number of user interactions by the set of users with each identified content item.

A second example method includes determining, based on user activity data, that a first user of a first platform has interacted with content of a content platform during a particular timeframe; identifying a first set of content items with which the first user has interacted during the particular timeframe; comparing a first dataset representing text in the first set of content items with a second dataset representing text in other content items with which other users of the first platform have interacted during the particular timeframe; identifying, based on comparing the first dataset and the second dataset, a list of content items that are similar to the first set of content items represented in the first dataset; and providing, for display in a user interface of the content platform, the list of content items.

In some implementations, comparing the first dataset representing text in the first set of content items with the second dataset representing text in other content items with which other users of the first platform have interacted during the particular timeframe, includes: generating the first dataset by numerically representing the text in the first set of content items; generating the second dataset by numerically representing the text in the other content items; and comparing, using a word-mover distance algorithm, the first dataset and the second dataset.

In some implementations, the second example method further includes: obtaining, from a user account repository stored on the first platform, first attribute data corresponding to the first user; inputting the first attribute data into a trained model, wherein the trained model is trained using attribute data for a plurality of users of the first platform and corresponding content preference data for the plurality of users; obtaining, using an output generated by the trained model in response to the input first attribute data, data identifying a set of users of the first platform who are expected to have similar content preferences as the first user; generating, using content with which the set of users has interacted, a second list of content items; and wherein providing, for display in the user interface of the content platform, the list of content items, comprises providing, for display in the user interface of the content platform, the second list of content items and the list of content items.

Similar operations and processes associated with each example system may be performed in different systems comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer-implemented software embodied on tangible, non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

The techniques described herein can be implemented to achieve the following advantages. For example, in some instances, the techniques described herein can further enhance the accuracy of the prediction of users who are expected to have similar content preferences as the user. In some implementations, the techniques described herein can provide data for a set of features associated with the user to a trained model that generates an output identifying other users of the content platform who are estimated to have similar content preferences as the user. In some implementations, the trained model can be a regression-based model, or a tree-based model with a linear regressor. Such a model can be highly accurate in its predictions because a tree-based model helps achieve generalization within established bounds, and when paired with a linear regressor, enables adequate extrapolation beyond the bounds.

As another example, in some implementations, the techniques described herein can reduce the amount of computing resources needed to make content recommendations. For example, the techniques can use filters to focus the analysis of content items on smaller subsets of content items, which requires fewer computing resources and less computing time compared to performing the analysis on all of the content items.

Furthermore, in some implementations where the techniques include analyzing content items of similar users, the techniques described herein can enable resource-efficient analysis of content items with which other users of the content platform have interacted. For example, data representing the user's prior content consumption history and data representing the other users' prior content consumption history can be represented numerically. Processing numerical representations of textual data requires less computing resources and computing time than processing textual data, and allows for efficient analysis and subsequent identification of related content. In addition, in some implementations, parallel processing techniques can be deployed to perform the comparison between data representing the user's prior content consumption history and data representing the other users' prior content consumption history, reducing the computing time.

As another example, in some implementations, the techniques described herein can be used to enhance a user's experience and increase the user's engagement with a content platform by providing personalized content recommendations without relying on prior user interactions. Unlike conventional recommender systems for content platforms that require prior user interaction with the platforms, the techniques described herein can generate recommendations from content items with which other users of the content platform, who are expected to have similar content preferences as the user, have interacted. The techniques herein can identify other users who are expected to have similar content preferences as the user based on information about the user and the user's account on a platform (e.g., a financial institution) with which the content platform is associated.

In this manner, the techniques described herein enable the generation and provision of personalized content recommendations to the user even though the user has no prior content consumption history with the content platform. For example, the techniques described herein can identify content that is contemporaneously consumed by similar users, or users with similar attributes and content preferences, of the platform with which the content platform is associated. The techniques described herein thus provide fresh content to the user, allowing for more engagement and user satisfaction with the content platform and a platform with which the content platform is associated.

In some implementations, the techniques described herein can be used to enhance a user's experience and increase the user's engagement with a content platform by providing personalized content recommendations when the user has previously interacted with content items on the content platform. For example, the techniques described herein can recommend content items that other users of the content platform have interacted with, that are similar to content items with which the user has previously interacted.

Moreover, the techniques described herein can ensure that recommendations are fresh and relevant. For example, when comparing the user's prior content consumption history and other users' prior content consumption history, the history can be limited to a particular timeframe, e.g., the previous 30 days, the previous 60 days, etc., as opposed to any time in the past. In addition, the techniques described herein can be used to further tailor recommendations to the user's interests. For example, if the user interacts with content on a daily basis, the recommendations provided may be based on content items that other users have interacted with more recently (e.g., within the last week or two). If the user interacts with content on a less frequent basis, such as once or twice a year (e.g., to consume content relating to tax filing), the recommendations provided may be based on content items that other users have interacted with during a longer timeframe (e.g., content related to tax planning and filing, which may be from over a year or two ago).

The details of one or more implementations are set forth in the accompanying drawings and the description, below. Other potential features and advantages of the disclosure will be apparent from the description and drawings, and from the claims

### DESCRIPTION OF DRAWINGS

FIG. 1 is a block diagram of an example environment in which content items are recommended to a user and provided for display on a user device.

FIG. 2 shows an example recommender system.

FIG. 3 is a flow diagram of an example process for providing recommendations.

FIG. 4 shows an example recommender system.

FIG. 5 is a flow diagram of an example process for providing recommendations.

FIG. 6 is a block diagram of an example computer system that can be used to perform operations described.

### DETAILED DESCRIPTION

The present disclosure generally relates to techniques for recommending content items to users of a content platform and in particular, recommending content items to users of a content platform that may not have previously interacted with content provided by the content platform.

Conventional content recommendation systems associated with a content platform generally require a user to have previously interacted with content items of the content platform in order to make content recommendations for the user. However, in some instances, the user may not have previously interacted with content items on the content platform. For example, the user may have just created an account on the content platform for the first time. In such instances, the content recommendation system may not be able to provide relevant content recommendations to the user.

In contrast, the techniques described herein enable recommending content items to users of a content platform without relying on prior user interactions. In some implementations the techniques described herein implement a content recommendation system associated with a platform that recommends content items to users who may not have prior interactions with the platform. For example, the content recommendation system can operate in the following manner. First, the system can determine, based on user activity data, that a user of a platform (e.g., a financial institution) has not interacted with content of a content platform (e.g., a website associated with the financial institution) during a particular timeframe. Next, the system can obtain, from a user account repository stored on the platform, attribute data corresponding to the user. The system can then input the attribute data into a trained model. The trained model is trained using attribute data for multiple users of the platform and corresponding content preference data for those users. Next, the system can obtain, using an output generated by the trained model in response to the input attribute data, data identifying a set of users of the platform who are expected to have similar content preferences as the user. The system can generate, using content with which the set of users has interacted, a list of content items. The system can then provide, for display in a user interface of the content platform, the list of content items to the user.

The techniques described herein can be used in the context of content recommendation systems. One skilled in the art will appreciate that the above described techniques are not limited to just this recommending content items application but can be applicable in other contexts. For example, in some implementations, the above described techniques can be used to recommend learning modules to users of a digital/online learning environment.

Further to the descriptions throughout this document, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

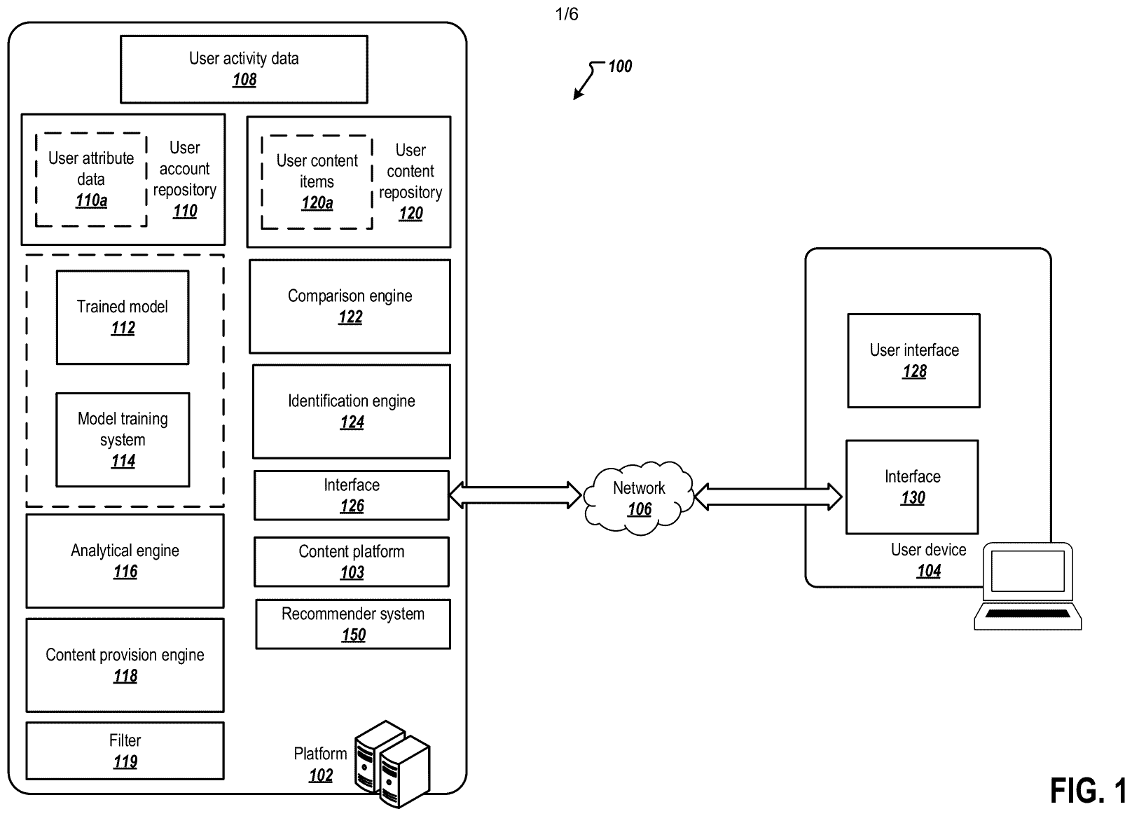

FIG. 1 is a block diagram of an example environment 100 in which content items are recommended to a user and provided for display on a user device. The example environment 100 includes a platform 102 and a user device 104 that are interconnected over a network 106. The function and operation of each of these components is described below.

The environment 100 enables the illustrated components to share and communicate information across devices and systems (e.g., platform 102 and user device 104) via network 106. As described herein, the platform 102 and user device 104 may be cloud-based components or systems (e.g., partially or fully), while in other instances, non-cloud-based systems may be used. In some instances, non-cloud-based systems, such as on-premises systems, client-server applications, and applications running on one or more client devices, as well as combinations thereof, may use or adapt the processes described herein. Although components are shown individually, in some implementations, functionality of two or more components, systems, or servers may be provided by a single component, system, or server. Conversely, functionality that is shown or described as being performed by one component, may be performed and/or provided by two or more components, systems, or servers.

The platform 102 may be any computer that can interact with the user device 104. As used in the present disclosure, the term “computer” is intended to encompass any suitable processing device such as, for example, a blade server, general-purpose personal computer (PC), Mac®, workstation, UNIX-based workstation, or any other suitable device. Moreover, although FIG. 1 illustrates a single platform 102, the platform 102 can be implemented using a single system or more than those illustrated, as well as computers other than servers, including a server pool. In other words, the present disclosure contemplates computers other than general-purpose computers, as well as computers without conventional operating systems.

The platform 102 includes or is associated with recommender system 150, content platform 103, user activity data 108, user account repository 110, trained model 112, model training system 114, analytical engine 116, content provision engine 118, user content repository 120, comparison engine 122, identification engine 124, and interface 126. In some implementations, the platform 102 can include or can be associated with filter 119. While illustrated as provided by or included in the platform 102, parts of the illustrated components/functionality of the platform 102 may be separate or remote from the platform 102, or the platform 102 may itself be distributed across the network 106.

As used in this specification, the term engine refers to hardware, e.g., one or more data processing apparatuses, that execute a set of programming to perform a set of tasks or operations.

The interface 126 of the platform 102 is used by the platform 102 for communicating with other systems in a distributed environment—including within the environment 100—connected to the network 106, e.g., the user device 104, and other systems communicably coupled to the illustrated platform 102 and/or network 106. Generally, the interface 126 comprises logic encoded in software and/or hardware in a suitable combination and operable to communicate with the network 106 and other components. More specifically, the interface 126 can comprise software supporting one or more communication protocols associated with communications such that the network 106 and/or interface's hardware is operable to communicate physical signals within and outside of the illustrated environment 100. Still further, the interface 126 can allow the platform 102 to communicate with the user device 104, and/or other portions illustrated within the platform 102 to perform the operations described herein.

A user of the platform 102 can have an account with the platform 102. For example, the platform 102 can be associated with a financial institution, and a user can have an account with the financial institution.

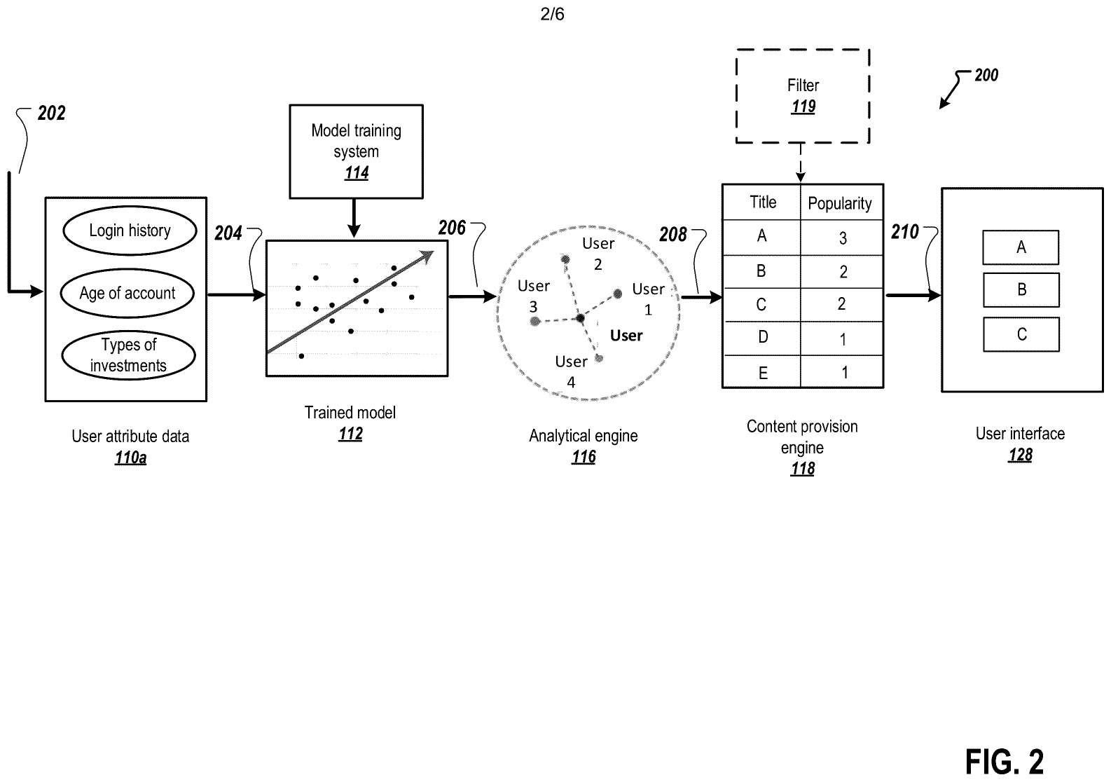

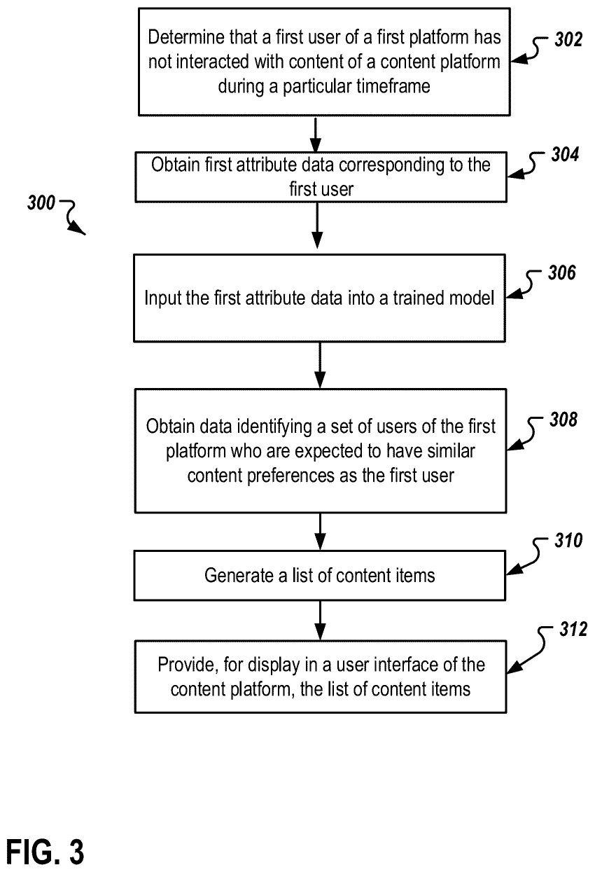

The recommender system 150 may be any application, program, other component, or combination thereof that enables providing recommendations to users of the platform 102 using other components of the platform 102. Example recommender systems are described below in FIGS. 2 and 3.

The content platform 103 may be any application, program, other component, or combination thereof that enables providing content to users of the platform 102. The content platform 103 may be a web application, desktop application, or mobile application. The content platform 103 may be part of or associated with platform 102 with which the user has an account. For example, the content platform 103 may be a web application that provides content items to users of the platform that is a financial institution. Content items can include, for example, news articles, blog posts, videos, and images.

User activity data 108 may be any application, program, other component, or combination thereof that enables storage of information about interactions with the content platform 103 by users of the platform 102. For example, information about an interaction with the content platform 103 by a user of the platform 102 can include a date and timestamp of the start of an interaction, a duration of the interaction, and information about user activity such as clicking, scrolling, or a rate of scrolling. Additionally, examples of interactions include user selection(s) to view content, a user spending a certain amount of time at a particular portion of a page that includes one or more content items, etc.

The user account repository 110 may be any application, program, other component, or combination thereof that enables storage of information about users of the platform 102. The user account repository 110 can be associated with the financial institution, for example. The user account repository 110 can store information such as demographic information or information about users' accounts on the platform 102. Demographic information can include, for example, a user's age, gender, occupation, and net worth. Information about the user's account on the platform can include, for example, account activity (which in the case of a financial institution, could include financial transaction/trading activity), login history, types of investments or holdings, and age of the account. The user account repository 110 can also store corresponding content preference data for users of the platform 102. For example, content preference data for a user can include data representing a list of content items with which the user has interacted. The content preferences for each user (if authorized for collection by such user) can be stored in the user account repository 110 and is determined or inferred based on express content preference selections by the particular user or based on the types of content with which interacted on the content platform.

The user account repository 110 includes user attribute data 110a. User attribute data 110a is the information stored in user account repository 110 associated with a user of user device 104. For example, user attribute data 110a may include the login history, age of account, and types of investments for a particular user.

The trained model 112 may be any application, program, other component, or combination thereof that receives user attribute data 110a about a user of the user device 104 and is trained to output a score that represents degree of similarity between the preferences of the user of the user device 104 and other users. The trained model 112 can be a machine learning model that is trained by the model training system 114.

The model training system 114 may be any application, program, other component, or combination thereof that enables training of the trained model 112 to predict a score that represents a degree of similarity between the preferences of the user of user device 104 and other users. In some implementations, the model training system 1114 curates training data comprising data regarding content interaction by multiple users of the content platform over a certain time period (e.g., 3 months, 6 months, one year, etc.).

The analytical engine 116 may be any application, program, other component, or combination thereof that enables identification of a set of users other than the user of user device 104 that are similar to the user of user device 104.

The content provision engine 118 may be any application, program, other component, or combination thereof that enables collection of a list of content items that users in a set of users have interacted with, and provision of content items. For a user of user device 104, the content provision engine 118 can generate a list of content items with which the set of users have interacted.

The filter 119 may be any application, program, other component, or combination thereof that enables filtering a list of content items. For example, content items can have features such as an age range, gender, or trading activity that are associated with the content item. The filter 119 can filter out content items from a list of content items that have features that do not meet one or more of the inputs to the filter (e.g., age, gender, and trading activity).

The user content repository 120 may be any application, program, other component, or combination thereof that enables storage of information about content items with which users of the content platform 103 have previously interacted. For example, information about a content item that users have previously interacted with can include a title, a link to the content item, the content of the content item, a list of users that have interacted with the content item, and a date and timestamp of interactions by the users that have interacted with the content item.

The user content repository 120 includes user content items 120a. User content items 120a is the information stored in user content repository 120 associated with a user of user device 104. For example, user content items 120a may include information about a set of content items with which a user of a particular user device 104 has interacted. The information can include, for each content item the user has interacted with, the title, link, content, and date and timestamp of the user's interaction with the content item.

The comparison engine 122 may be any application, program, other component, or combination thereof that enables comparison of a dataset representing text in the set of content items in user content items 120a and a dataset representing text in the content items in user content repository 120. For example, the dataset representing text in the set of content items in user content items 120a can be a title of a content item in user content items 120a. The dataset representing text in the content items in user content repository 120 can be a title of a content item in user content repository 120.

The identification engine 122 may be any application, program, other component, or combination thereof that enables identification of a list of content items that are similar to the set of content items in user content items 120a. For example, the list of content items can include a content item in user content repository 120 that has a similar title as a content item in the set of content items in user content items 120a.

One or more user devices 104 may be present in the example environment 100. Although FIG. 1 illustrates a single user device 104, multiple user devices may be deployed. Each user device 104 may be associated with a particular user (e.g., an employee or a customer of a financial institution), or may be accessed by multiple users, where a particular user is associated with a current session or interaction at the user device 104. User device 104 may be a client device at which the user is linked or associated, or a client device through which the user interacts with the platform 102. As illustrated, the user device 104 may include an interface 130 for communication (which may be operationally and/or structurally similar to interface 126 and a user interface 128).

The illustrated user device 104 is intended to encompass any computing device such as a desktop computer, laptop/notebook computer, mobile device, smartphone, personal data assistant (PDA), tablet computing device, one or more processors within these devices, or any other suitable processing device. In general, the user device 104 and its components may be adapted to execute any operating system. In some instances, the user device 104 may be a computer that includes an input device, such as a keypad, touch screen, or other device(s) that can interact with one or more client applications, such as one or more mobile applications, including for example a web browser, a banking application, or other suitable applications, and an output device that conveys information associated with the operation of the applications and their application windows to the user of the user device 104. Such information may include digital data, visual information, or a user interface 128, as shown with respect to the user device 104. Specifically, the user device 104 may be any computing device operable to communicate with the platform 102 and/or other components via network 106, as well as with the network 106 itself, using a wireline or wireless connection. In general, the user device 104 comprises an electronic computer device operable to receive, transmit, process, and store any appropriate data associated with the environment 100 of FIG. 1.

The user device 104 may be a desktop system, a client terminal, or any other suitable device, including a mobile device, such as a smartphone, tablet, smartwatch, or any other mobile computing device. In general, each illustrated component may be adapted to execute any suitable operating system, including Linux, UNIX, Windows, Mac OS®, Java™, Android™, Windows Phone OS, or iOS™, among others. The user device 104 may include one or more merchant- or financial institution-specific applications executing on the user device 104, or the user device 104 may include one or more Web browsers or web applications that can interact with particular applications executing remotely from the user device 104, such as the content platform 103, among others.

User interface 128 of the user device 104 interfaces with at least a portion of the environment 100 for any suitable purpose, including generating a visual representation of the content associated with any components of the platform 102. For example, the user interface 128 can be used to present screens and information associated with the content platform 103. User interface 128 may also be used to view and interact with various web pages, applications, and web services located locally or externally to the user device 104. Generally, the user interface 128 provides the user with an efficient and user-friendly presentation of data provided by or communicated within the system. The user interface 128 may comprise a plurality of customizable frames or views having interactive fields, pull-down lists, and buttons operated by the user. In general, the user interface 128 is often configurable, supports a combination of tables and graphs (bar, line, pie, status dials, etc.), and is able to build real-time portals, application windows, and presentations. Therefore, the user interface 128 contemplates any suitable graphical user interface, such as a combination of a generic web browser, a web-enabled application, intelligent engine, and command line interface (CLI) that processes information in the platform and efficiently presents the results to the user visually.

The network 106 facilitates wireless or wireline communications between the components of the environment 100 (e.g., between the platform 102 and user device 104), as well as with any other local or remote computers, such as additional mobile devices, clients, servers, or other devices communicably coupled to network 106, including those not illustrated in FIG. 1. In the illustrated environment, the network 106 is depicted as a single network, but may be comprised of more than one network without departing from the scope of this disclosure, so long as at least a portion of the network 106 may facilitate communications between senders and recipients. In some instances, one or more of the illustrated components may be included within or deployed to network 106 or a portion thereof as one or more cloud-based services or operations. The network 106 may be all or a portion of an enterprise or secured network, while in another instance, at least a portion of the network 106 may represent a connection to the Internet. In some instances, a portion of the network 106 may be a virtual private network (VPN). Further, all or a portion of the network 106 can comprise either a wireline or wireless link. Example wireless links may include 802.11a/b/g/n/ac, 802.20, WiMax, LTE, and/or any other appropriate wireless link. In other words, the network 106 encompasses any internal or external network, networks, sub-network, or combination thereof operable to facilitate communications between various computing components inside and outside the illustrated environment 100. The network 106 may communicate, for example, Internet Protocol (IP) packets, Frame Relay frames, Asynchronous Transfer Mode (ATM) cells, voice, video, data, and other suitable information between network addresses. The network 106 may also include one or more local area networks (LANs), radio access networks (RANs), metropolitan area networks (MANs), wide area networks (WANs), all or a portion of the Internet, and/or any other communication system or systems at one or more locations.

While portions of the elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

FIG. 2 shows an example recommender system 200. The system 200 can make a determination 202 that a user of a platform 102 has not interacted with content of a content platform 103 during a particular timeframe (e.g., the last 10-15 days, the last 1-2 years, the last 30 days, the last 60 days, the last 90 days, a period of 30 days, a period of 90 days, etc.). In some implementations, the determination 202 can be made based on user activity data 108, described above with reference to FIG. 1. For example, the system 200 can use the date and timestamps associated with the user's interactions in user activity data 108 to determine that the user has not interacted with content of content platform 103 during a particular time window (e.g., the past week, month, or three months).

The system 200 can obtain user attribute data 110a corresponding to the user. For example, types of user attribute data 110a can include login history for the user at platform 102, age of an account of the user at platform 102, and types of investments held in the account of the user. Other examples of user attribute data 110a can include the user's age, gender, occupation, or net worth, and the trading activity of the account of the user.

The system 200 can input the user attribute data 204 as a target output to a trained model 112. The model training system 114 can train a machine learning model using attribute data and corresponding preference data for other users of the platform, e.g., attribute data from the user account repository 110 of FIG. 1. The model training system 114 can train the machine learning model to predict a score that represents a degree of similarity between the preferences of the user and other users to generate a trained model 112. That is, the score indicates the likelihood that the user has content preferences similar to those of another user. The system can use the trained model 112 to generate a score that represents a degree of similarity between the preferences of the user and x other users, where x is an integer greater than or equal to one. For example, a higher score between the user and another user can represent a higher estimate of the similarity between the content preferences of the users.

In some implementations, the trained model can be a regression-based machine learning model, which can be trained using a supervised training method using training data that includes a set of attribute data and corresponding preference data for other users of the platform. In some implementations, the regression-based machine learning model can be a tree-based model with a linear regressor.

The system 200 can provide the predicted scores that represent a degree of similarity 206 between the preferences of the user and other users to the analytical engine 116. The analytical engine can generate data 208 identifying a set of m users, where m is an integer greater than or equal to one, who are expected to have the most similar content preferences to the user. For example, the data 208 in FIG. 2 identifies a set of four users, User 1, User 2, User 3, and User 4, that have the highest score to the user among the x users that the trained model 112 generated a score for. Alternatively, in some implementations, a set of users with similar content preferences can be identified by the analytical engine 116 if the scores for this set of users satisfies (e.g., meets or exceeds) a particular threshold.

The system 200 can provide the data 208 to the content provision engine 118. The content provision engine 118 can collect a list of content items that users in the output data 208 have interacted with. For example, the content provision engine 118 can obtain content interaction history for users in the data 208 from a user content repository, such as the user content repository 120 of FIG. 1, and generate a list of content items the users have interacted with. For example, FIG. 2 shows that Users 1, 2, 3, and 4, have interacted with content items titled “A,” “B,” “C,” D,” and “E.”

In some implementations, the filter 119 can filter the list of content items that users in the data 208 have interacted with. For example, content items can have features such as an age range, gender, or trading activity that are associated with the content item. The filter 119 can use the age, gender, and trading activity of the user to filter out content items from the list of content items that have features that do not meet one or more of the age, gender, and trading activity of the user.

The content provision engine 118 can rank the popularity of each content item in the list. For example, the content provision engine 118 can collect a list of content items by title that User 1, User 2, User 3, and User 4 interacted with using user account repository 110. The content provision engine 118 can obtain a popularity for each content item in the list of content items based on a number of user interactions by the set of m users with each content item. For example, the popularity can be obtained by counting the number of times each content item appears in the list. For example, FIG. 1 shows that the content item titled “A” has a popularity of two, the content item titled “B” has a popularity of two, the content item titled “D” has a popularity of two, the content item titled “D” has a popularity of one, and the content item titled “E” has a popularity of one. The content item titled “A” has a popularity of three, which can indicate, for example, that three users out of Users 1, 2, 3, and 4 have interacted with the content item titled “A.” The popularity can also indicate the total number of interactions Users 1, 2, 3, and 4 had with the content item titled “A.” For example, User 1 could have interacted with the content item titled “A” once, and User 2 could have interacted with the content item titled “A” twice, for a total popularity of three.

The content provision engine 118 can generate a list 210 of the top n most popular content items, where n is an integer greater than or equal to one. For example, FIG. 1 shows that the list 210 contains the top three most popular content items.

The system 200 can provide the list of content items 210 to the user interface 128 of the content platform 103 for display to the user. For example, the list of content items 210 in FIG. 2 includes the content items titled “A,” “B,” and “C.” The list can include links to webpages displaying the content of the content items. The system can provide the list of content items 210 to the content platform 103 that is a web application. The content platform 103 can use the interface 126 to communicate with the interface 130 on the user device. The content platform can send the list of content items 210 to the user device, and display the list of content items 210 to the user through the user interface 128.

In this manner, user attribute data of the user can be used by the system 200 (including its trained model 112) to identify similar users of the content platform and use the content viewed or interacted with by such similar users to identify content items to provide to the user of the user device. As a result, system 200 enables the content platform to provide specific content items to the user of the user device even if the user of the user device has not previously viewed or otherwise interacted with any content on the content platform.

FIG. 3 is a flow diagram of an example process 300 for providing recommendations. For convenience, the process 300 will be described as being performed by a system of one or more computers located in one or more locations. For example, a recommender system, e.g., the recommender system 200 of FIG. 2, appropriately programmed in accordance with this specification, can perform the process 300. Operations of the process 300 can also be implemented as instructions stored on one or more computer readable media, which may be non-transitory, and execution of the instructions by one or more data processing apparatus can cause the one or more data processing apparatus to perform the operations of the process 300.

The system determines, based on user activity data, that a first user of a first platform has not interacted with content of a content platform during a particular timeframe (step 302). The first user can be the user of the user device 104 described in FIG. 1. The first platform can be the platform 102, and the content platform can be the content platform 103. In some implementations, the system can access a repository such as user account repository 110 that stores content interaction and consumption history for various users, and determine whether the first user has any prior consumption history stored in the repository (as described with reference to FIGS. 1-2).

The system obtains, from a user account repository stored on the first platform, first attribute data corresponding to the first user (step 304). The first attribute data can be the user attribute data 110a of FIG. 1. For example, first attribute data can include login history for the first user at the first platform, age of an account of the first user at the first platform, and types of investments held in the account of the first user. Other examples of first attribute data can include the first user's age, gender, occupation, or net worth, and the trading activity of the account of the first user.

The system inputs the first attribute data into a trained model, wherein the trained model is trained using attribute data for a plurality of users of the first platform and corresponding content preference data for the plurality of users (step 306). The trained model can be the trained model 112 of FIG. 1. The trained model can be a regression-based machine learning model, which can be trained using a supervised training method. For example, the trained model can be a tree-based model with a linear regressor. In some implementations, the trained model is trained to optimize an objective function and uses training data for such training, where the training data includes historical user attribute data and content preference data for multiple users on the content platform (as collected and/or obtained for different periods, e.g., the last 6 months, the last year, etc.).

The system obtains, using an output generated by the trained model in response to the input first attribute data, data identifying a set of users of the first platform who are expected to have similar content preferences as the first user (step 308). For example, the data can include a list of users of the first platform and corresponding scores that represent a degree of similarity of content preferences between the first user and each respective user in the list of users. The system can select a subset of users from among the set of users based on the scores.

The system generates, using content with which the set of users has interacted, a list of content items (step 310). The system can use the content provision system 118 of FIG. 1. For example, the system can identify content items with which each user in the set of users has interacted with and generate the list of content items from among the identified content items based on a number of user interactions by the set of users with each identified content item (as described with reference to FIGS. 1-2).

The system provides, for display in a user interface of the content platform, the list of content items (step 312), as described with reference to FIGS. 1-2.

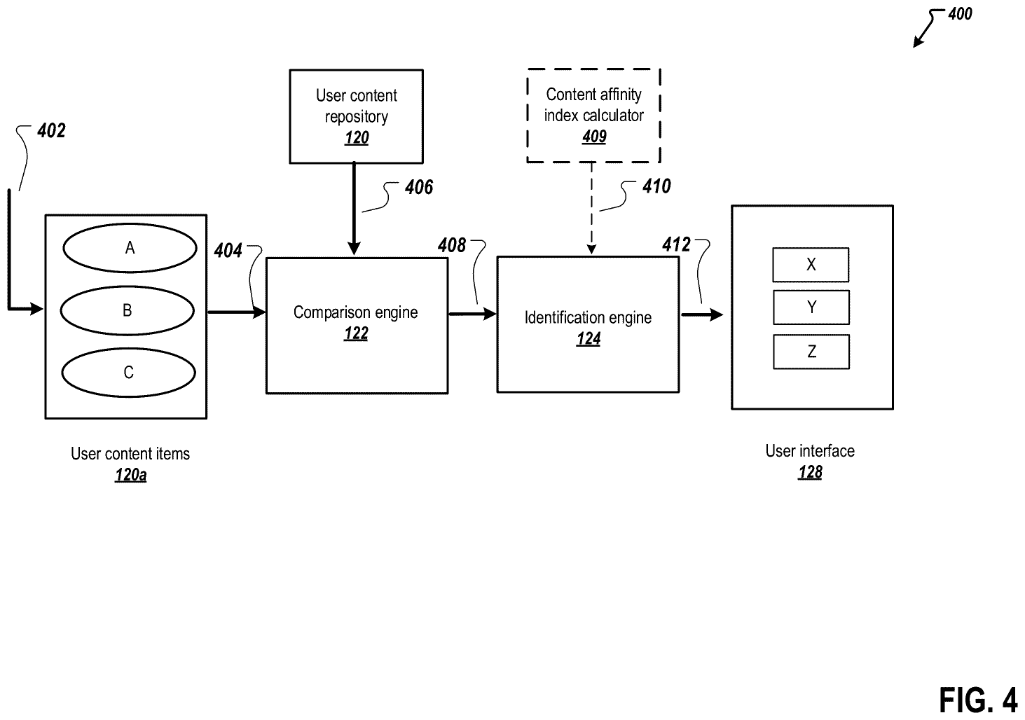

FIG. 4 shows an example recommender system 400. The system 400 can make a determination 402 that a user of a platform 102 has interacted with content of a content platform 103 during a particular timeframe. In some implementations, the determination 402 can be made based on user activity data 108, described above with reference to FIG. 1. For example, the system 400 can use the date and timestamps associated with the user's interactions in user activity data 108 to determine that the user has interacted with content of content platform 103 during the past week, month, or three months, for example.

The system 400 can identify a set of content items, user content items 120a, with which the user has interacted during the particular timeframe. For example, the system can identify the set of content items using the date and timestamps associated with user interactions in user content items 120a stored in the user content repository 120 of FIG. 1.

The system 400 can generate a first dataset 404 representing text in the set of content items with which the user has interacted during the particular timeframe. The system 400 can generate a second dataset 406 representing text in content items with which other users of the content platform 103 have interacted during the particular timeframe. For example, the other users can include users that have interacted with the content platform during the particular timeframe. To generate the second dataset 406, the system can obtain the content items with which other users of the content platform 103 have interacted during the particular timeframe from the user content repository 120. The text can include the titles of the content items. In some implementations, the text can be translated into an N-dimensional, for example, 100-dimensional, numerical representation of the underlying text. For example, the text can be represented as a word embedding with a vector that has a length N. For example, the system 400 can use a model (e.g., word2vec algorithms) that has been trained on existing content items to obtain a mapping between text and vector space, and thus represent the text as a word embedding.

The system 400 can input the first dataset 404 and second dataset 406 into a comparison engine 122. The comparison engine 122 can compare each title in the first dataset 404 and each title in the second dataset 406 to calculate a measure of similarity between each title in the first dataset 404 and each title in the second dataset 406. For example, the comparison engine 122 can include a word-mover distance algorithm that identifies a word-mover distance between each title in the first dataset 404 and each title in the second dataset 406. A smaller word-mover distance between a title in the first dataset 404 and a title in the second dataset 406 indicates that the two titles are similar types of content, while a larger word-mover distance indicates the two titles are less similar types of content. For example, the comparison engine 122 can perform a word-by-word comparison of each word in a first title against each word in a second title, and add the smallest word-mover distance between each pair of words to obtain a word-mover distance between the first and second titles. For example, if a first title was “stocks fall amid recession concerns” and a second title was “stocks fall for second day,” the comparison engine 122 can compare the first word in the first title, “stocks,” with the first word in the second title, “stocks,” and obtain a word-mover distance between the two words in vector space. The comparison engine 122 can then obtain a word-mover distance between the first word in the first title, “stocks,” and the second word in the second title, “fall.” The comparison engine 122 can obtain word-mover distances between the first word in the first title, “stocks,” and the remaining words in the second title, “for,” “second,” and “day.” The comparison engine 122 can store the smallest word-mover distance for the comparisons for the first word, and then add this smallest word-mover distance for the first word to comparisons for all the other words in the first title (e.g., the smallest word-mover distances for comparisons of “fall,” “amid,” “recession,” and “concerns” to every word in the second title) to obtain a word-mover distance between the first title and the second title. A smaller word-mover distance between two words, for example, in the vector space, indicates that the two words have more similar meanings than another two words that have a larger word-mover distance. For example, the distance can be a L1-norm or Manhattan distance. The measure of similarity between each title in the first dataset 404 and each title in the second dataset 406 can thus be the word-mover distance between each title.

Although a distance-based algorithm operating on numerical representations of textual content is described above, other textual comparison algorithms can be deployed to identify similar content to the one that the user has previously consumed.

In some implementations, parallel processing techniques can be deployed, e.g., by utilizing multiple cores, to perform the repetitive tasks of comparing the set of content items with which the user has interacted during the particular timeframe with content items with which other users of the content platform have interacted (e.g., as consumed during a particular timeframe). This enables faster and in-parallel processing of the dataset comparisons relative to a linear processing of the same dataset comparison.

Based on the above output of the word-mover distance algorithm (or another text distance-based algorithm), the system can provide a list of titles in the second dataset 406 and their associated measures of similarity to each title in the first dataset 404, comparison output data 408, to an identification engine 124. For example, a smaller word-mover distance can represent a higher measure of similarity. The identification engine 124 can identify a list of titles from the set of content items represented in the second dataset 406 that are most similar to the titles from the set of content items represented in the first dataset 404. For example, the identification engine 124 can identify a list of the top-n titles with the highest measure of similarity to any title in the first dataset 404, where n is an integer greater than or equal to one, as the list of titles.

In some implementations, the system 400 can also include a content affinity index calculator 409 to calculate a content affinity index 410. The identification engine 124 can compute final scores for each title in the list of titles in the second dataset 406 based on the measure of similarity between the title in the second dataset 406 and each title in the first dataset 404, as described above, and a content affinity index 410. The final score s can be calculated according to the following equation:

$$s = α * similarity + β * ( content affinity )$$

where α and β are parameters that can be defined, similarity is the measure of similarity between a title in the second dataset 406 and a title in the first dataset 404, and content affinity is the content affinity index 410 between the title in the second dataset 406. In some implementations, the similarity can be scaled so that a higher similarity indicates a smaller word-mover distance, and a lower similarity indicates a larger word-mover distance.

The content affinity index calculator 409 can include a filter for features such as age range, gender, or trading activity. For example, a title that is not associated with any features indicates that the title is suitable for any age, gender, or trading activity. If a title is associated with a feature that is an age range of 20 to 30, for example, and the user has an age of 32, the content affinity index calculator 409 can filter out the title and remove the title from the list of titles.

The content affinity index 410 can include a tag affinity, a measure of the user's tag consumption during the particular timeframe. Each title on the content platform can be associated with tags that designate a subject or category for the content item, such as “tech,” “stocks,” “economy,” and “family.” The user's tag affinity can be computed by associating each tag with a proportion of the number of occurrences of the tag in the total number of tags. In some implementations, for example, the titles, tags, and content identifiers can be stored in a database. Content identifiers can include, for example, website links to the content, or a number or label that is uniquely associated with the content. The database can also include information about each content item, such as a length if the content item is a video.

For example, if there are four titles in the first dataset 404, meaning that the user has interacted with four titles during the particular timeframe, each can be associated with one or more tags. The titles could have tags of “tech,” “tech,” “stocks,” and “family.” The total number of tags is four, the number of occurrences of the tag “tech” is two, the number of occurrences of the tag “stocks” is one, and the number of occurrences of the tag “family” is one. Thus, the tag affinity for the user is 0.5 for “tech”, 0.25 for “stocks,” and 0.25 for “family.”

The content affinity index calculator 409 can apply the user's tag affinity to the content affinity index 410 for each title in the second dataset 406. The content affinity index calculator 409 can add the values in the user's tag affinity for each tag that is associated with the title in the second dataset 406. For example, if the title in the second dataset 406 is associated with the tags “tech,” “stocks,” and “economy,” the content affinity index calculator 409 applies the user's tag affinity and adds 0.5 for “tech” and 0.25 for “stocks” to get a content affinity index 410 of 0.75.

The system can provide the content affinity index 410 to the identification engine 124. As described above, the identification engine 124 can compute final scores (using, e.g., the computation described above) for each title in the list of titles in the second dataset 406 based on the measure of similarity between the title in the second dataset 406 and each title in the first dataset 404, as described above, and the content affinity index 410. The identification engine 124 can identify a list of titles that have the highest final score using the similarity and content affinity index 410. For example, the identification engine 124 can identify a list of the top-n titles with the highest final score, where n is an integer greater than or equal to one, as the list of titles.

The identification engine 124 can associate the list of titles, either with the highest measure of similarity or the highest final score, with the content for the title or a link to a webpage displaying the content for the title to identify a list of content items 412. For example, the list of content items 412 can include titles or links to the content items.

The system 400 can provide the list of content items 412 to the user interface 128 of the content platform 103 for display to the user. For example, the list of content items 412 in FIG. 4 includes the content items titled “X,” “Y,” and “Z.” The list can include links to webpages displaying the content of the content items. The system can provide the list of content items 412 to the content platform 103 that is a web application. The content platform 103 can use the interface 126 to communicate with the interface 130 on the user device. The content platform can send the list of content items 412 to the user device, and display the list of content items 412 to the user through the user interface 128.

In some implementations, the list of content items 412 provided for display may be based on the content consumed by the user during a particular timeframe, which informs how often a particular user visits or digests content on the content platform 103. For example, if a user consumes or interacts with content on a daily basis, the list of content items may be based on content that was interacted with by other users during a shorter timeframe, e.g., the last 10 to 15 days. As another example, if a user consumes or interacts with tax-related content on a limited basis, e.g., once or twice a year, the list of content items may be based on tax-related content that was interacted with by other users during a longer timeframe, e.g., the last one to two years.

In this manner, user content items that the user has previously interacted with can be used by the system 400 to identify similar content items on the content platform that other users of the content platform have interacted with. As a result, system 400 enables the content platform to provide personalized and relevant content items to the user of the user device.

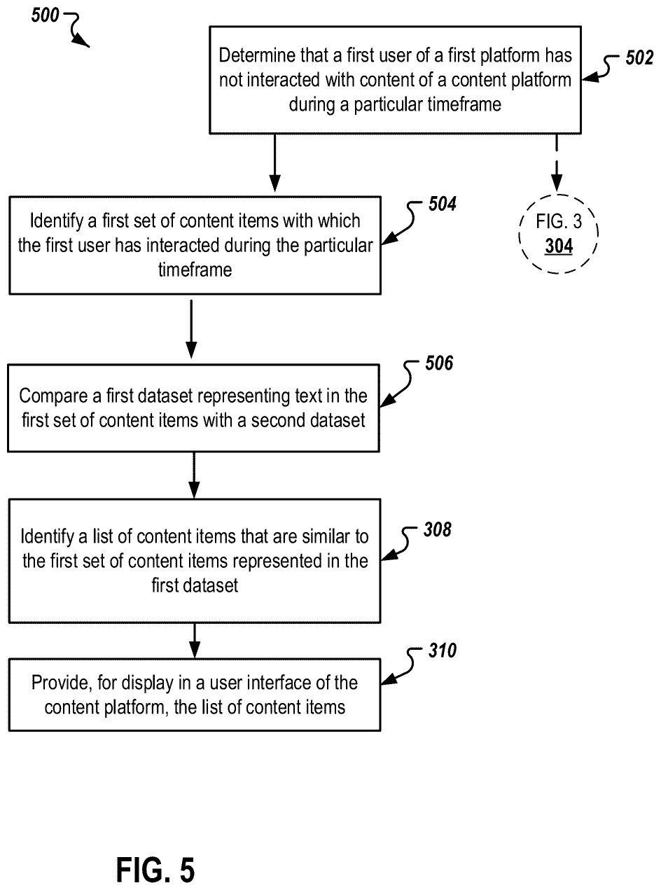

FIG. 5 is a flow diagram of an example process 500 for providing recommendations. For convenience, the process 500 will be described as being performed by a system of one or more computers located in one or more locations. For example, a recommender system, e.g., the recommender system 400 of FIG. 4, the recommender system 200 of FIG. 2, or components of one or both of the recommender system 400 and recommender system 200, appropriately programmed in accordance with this specification, can perform the process 500. Operations of the process 500 can also be implemented as instructions stored on one or more computer readable media, which may be non-transitory, and execution of the instructions by one or more data processing apparatus can cause the one or more data processing apparatus to perform the operations of the process 500.

The system determines, based on user activity data, that a first user of a first platform has interacted with content of a content platform during a particular timeframe (step 502). In some implementations, the system can access a repository that stores content interaction and consumption history for various users, and determine whether the first user has any prior consumption history stored in the repository (as described with reference to FIGS. 2-4).

The system identifies a first set of content items with which the first user has interacted during the particular timeframe (step 504), as described with reference to FIG. 4.

The system compares a first dataset representing text in the first set of content items with a second dataset representing text in other content items with which other users of the first platform have interacted during the particular timeframe (step 506). For example, the system can generate the first dataset by numerically representing the text in the first set of content items, generate the second dataset by numerically representing the text in the other content items. In some examples, the system can use N-dimensional numerical representations.

For example, the system can compare the first dataset and the second dataset using a word-mover distance algorithm (as described with reference to FIG. 4). A word-mover distance algorithm identifies a word-mover distance between the first user's consumed content and other content on the content platform, which may be content consumed on the platform during a particular timeframe. The smaller the word-mover distance, the closer or more similar the other content is to the type of content that the first user has consumed. The larger the word-mover distance, the farther or less similar the other content is to the type of content that the first user has consumed.

In some implementations, the system can use parallel processing when comparing the first dataset and the second dataset.

The system identifies, based on comparing the first dataset and the second dataset, a list of content items that are similar to the first set of content items represented in the first dataset (step 508). For example, the system can identify a number of the content items that have the smallest word-mover distance as the list of content items (as described with reference to FIG. 4).

The system provides, for display in a user interface of the content platform, the list of content items (step 510). In some implementations, the list of content items provided for display may be based on the content consumed by the user during a particular timeframe. For example, if a user consumes or interacts with content on a daily basis, the list of content items may be based on content that was interacted with by other users during a shorter timeframe. As another example, if a user consumes or interacts with tax-related content on a limited basis, such as once or twice a year, the list of content items may be based on tax-related content that was interacted with by other users during a longer timeframe.

In some implementations, the system can also perform steps 304 to 312 of FIG. 3 using the environment of FIG. 1 and the system of FIG. 2, so that the list of content items provided for display can be a combination of (1) content items with which a set of users similar to the first user have interacted and (2) content items that are similar to the content items the first user has interacted with. For example, the system can obtain, from a user account repository stored on the first platform, first attribute data corresponding to the first user; input the first attribute data into a trained model, wherein the trained model is trained using attribute data for a plurality of users of the first platform and corresponding content preference data for the plurality of users; obtain, using an output generated by the trained model in response to the input first attribute data, data identifying a set of users of the first platform who are expected to have similar content preferences as the first user; generate, using content with which the set of users has interacted, a second list of content items; and provide, for display in the user interface of the content platform, the list of content items, comprises providing, for display in the user interface of the content platform, the second list of content items and the list of content items.

The above description is provided in the context of content items and in particular, recommending content items to users of a content platform. One skilled in the art will appreciate that the above described techniques are not limited to just this recommending content items application but can be applicable in other contexts. For example, in some implementations, the above described techniques can be used to recommend learning modules to users of a digital/online learning environment. Using the above-described system, customized learning modules can be recommended and provided to a user based on the user's existing skill level. For example, where a user has an account with a financial institution, the system can determine the user's existing skill level in the context of investment/trading scenarios based on attribute data, e.g., the age of the user's account, the types of investments (options, stock, etc.) in the account, and the amount of money in the account. The system can generate and provide learning modules that are tailored for the user's skill level based on the learning modules that similar users of the digital/online learning environment have interacted with, or learning modules similar to those the user has previously interacted with.

As another example, the above described techniques can be used to make recommendations to a user of a platform who has an account on the platform but has not interacted with particular information on the platform. For example, the system can provide recommendations to a user of a shopping platform who has not yet interacted with any items/services or made purchases. The system can determine the types of items/services in which the user may be interested based on data associated with the user's account, e.g., the age of the user's account, or the address on the account, and generate and provide recommendations for items/services that similar users on the shopping platform have interacted with.

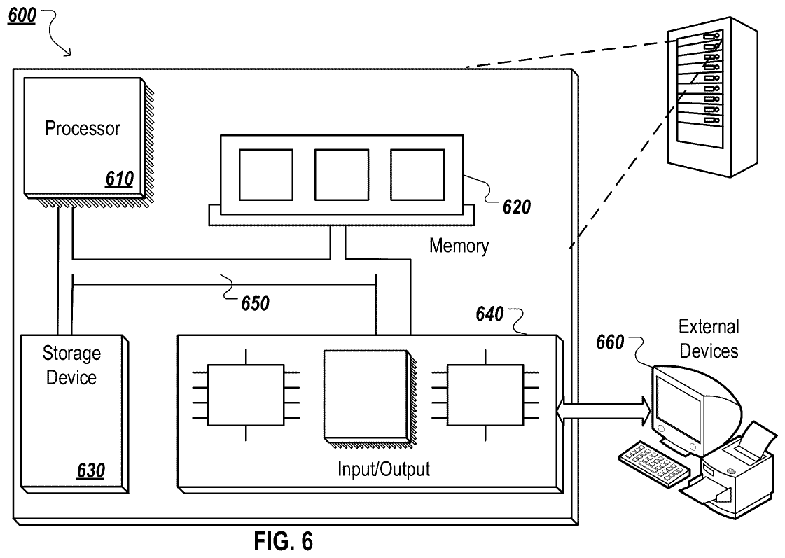

FIG. 6 is a block diagram of an example computer system 600 that can be used to perform operations described. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In some implementations, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In some implementations, the memory 620 is a volatile memory unit. In another implementation, the memory 620 is a non-volatile memory unit.

The storage device 630 is capable of providing mass storage for the system 600. In some implementations, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In some implementations, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to external devices 660, e.g., keyboard, printer and display devices. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

As used in this document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files. For example, the digital component may be content that is intended to supplement content of a video or other resource. More specifically, the digital component may include digital content that correlates to resource content (e.g., the digital component may relate to a topic that is the same as or otherwise related to the topic/content on a video). The provision of digital components can thus supplement, and generally enhance, the web page or application content.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
determining, based on user activity data, that a first user of a first platform has not interacted with content of a content platform during a particular timeframe;
obtaining, from a user account repository stored on the first platform, first attribute data corresponding to the first user;
inputting the first attribute data into a trained model, wherein the trained model is trained using attribute data for a plurality of users of the first platform and corresponding content preference data for the plurality of users;
obtaining, using an output generated by the trained model in response to the input first attribute data, data identifying a set of users of the first platform who are expected to have similar content preferences as the first user;
generating, using content with which the set of users has interacted, a list of content items; and
providing, for display in a user interface of the content platform, the list of content items.

2. The computer-implemented method of claim 1, wherein the trained model is a tree-based model with a linear regressor.

3. The computer-implemented method of claim 1, wherein the first attribute data includes data for a plurality of attributes, including login history for the first user at the first platform, age of an account of the first user at the first platform, and types of investments held in the account of the first user.

4. The computer-implemented method of claim 1, wherein the data identifying a set of users of the first platform who are expected to have similar content preferences as the first user includes a list of users of the first platform and corresponding scores representing a degree of similarity of content preferences between the first user and each respective user in the list of users; and
the method further comprising selecting, based on the scores, the set of users from among the users listed in the list of users.

5. The method of claim 1, wherein generating, using content with which the set of users has interacted, the list of content items, comprises:
identifying content items with which each user in the set of users has interacted; and
generating the list of content items from among the identified content items based on a number of user interactions by the set of users with each identified content item.

6. A system comprising:
at least one memory storing instructions; and
at least one hardware processor interoperably coupled with the at least one memory, wherein execution of the instructions by the at least one hardware processor causes performance of operations comprising:
determining, based on user activity data, that a first user of a first platform has not interacted with content of a content platform during a particular timeframe;
obtaining, from a user account repository stored on the first platform, first attribute data corresponding to the first user;
inputting the first attribute data into a trained model, wherein the trained model is trained using attribute data for a plurality of users of the first platform and corresponding content preference data for the plurality of users;
obtaining, using an output generated by the trained model in response to the input first attribute data, data identifying a set of users of the first platform who are expected to have similar content preferences as the first user;
generating, using content with which the set of users has interacted, a list of content items; and
providing, for display in a user interface of the content platform, the list of content items.

7. The system of claim 6, wherein the trained model is a tree-based model with a linear regressor.

8. The system of claim 6, wherein the first attribute data includes data for a plurality of attributes, including login history for the first user at the first platform, age of an account of the first user at the first platform, and types of investments held in the account of the first user.

9. The system of claim 6, wherein the data identifying a set of users of the first platform who are expected to have similar content preferences as the first user includes a list of users of the first platform and corresponding scores representing a degree of similarity of content preferences between the first user and each respective user in the list of users; and
the operations further comprising selecting, based on the scores, the set of users from among the users listed in the list of users.

10. The system of claim 6, wherein generating, using content with which the set of users has interacted, the list of content items, comprises:
identifying content items with which each user in the set of users has interacted; and
generating the list of content items from among the identified content items based on a number of user interactions by the set of users with each identified content item.

11. A non-transitory, computer-readable medium storing computer-readable instructions, that upon execution by at least one hardware processor, cause performance of operations, comprising:
determining, based on user activity data, that a first user of a first platform has not interacted with content of a content platform during a particular timeframe;
obtaining, from a user account repository stored on the first platform, first attribute data corresponding to the first user;
inputting the first attribute data into a trained model, wherein the trained model is trained using attribute data for a plurality of users of the first platform and corresponding content preference data for the plurality of users;
obtaining, using an output generated by the trained model in response to the input first attribute data, data identifying a set of users of the first platform who are expected to have similar content preferences as the first user;
generating, using content with which the set of users has interacted, a list of content items; and
providing, for display in a user interface of the content platform, the list of content items.

12. The non-transitory, computer-readable medium of claim 11, wherein the trained model is a tree-based model with a linear regressor.

13. The non-transitory, computer-readable medium of claim 11, wherein the first attribute data includes data for a plurality of attributes, including login history for the first user at the first platform, age of an account of the first user at the first platform, and types of investments held in the account of the first user.

14. The non-transitory, computer-readable medium of claim 11, wherein the data identifying a set of users of the first platform who are expected to have similar content preferences as the first user includes a list of users of the first platform and corresponding scores representing a degree of similarity of content preferences between the first user and each respective user in the list of users; and
the operations further comprising selecting, based on the scores, the set of users from among the users listed in the list of users.

15. The non-transitory, computer-readable medium of claim 11, wherein generating, using content with which the set of users has interacted, the list of content items, comprises:
identifying content items with which each user in the set of users has interacted; and
generating the list of content items from among the identified content items based on a number of user interactions by the set of users with each identified content item.

16. A computer-implemented method, comprising:
determining, based on user activity data, that a first user of a first platform has interacted with content of a content platform during a particular timeframe;
identifying a first set of content items with which the first user has interacted during the particular timeframe;
comparing a first dataset representing text in the first set of content items with a second dataset representing text in other content items with which other users of the first platform have interacted during the particular timeframe;
identifying, based on comparing the first dataset and the second dataset, a list of content items that are similar to the first set of content items represented in the first dataset; and
providing, for display in a user interface of the content platform, the list of content items.

17. The computer-implemented method of claim 16, wherein comparing the first dataset representing text in the first set of content items with the second dataset representing text in other content items with which other users of the first platform have interacted during the particular timeframe, comprises:
generating the first dataset by numerically representing the text in the first set of content items;
generating the second dataset by numerically representing the text in the other content items; and
comparing, using a word-mover distance algorithm, the first dataset and the second dataset.

18. The computer-implemented method of claim 16, further comprising:
obtaining, from a user account repository stored on the first platform, first attribute data corresponding to the first user;
inputting the first attribute data into a trained model, wherein the trained model is trained using attribute data for a plurality of users of the first platform and corresponding content preference data for the plurality of users;
obtaining, using an output generated by the trained model in response to the input first attribute data, data identifying a set of users of the first platform who are expected to have similar content preferences as the first user;
generating, using content with which the set of users has interacted, a second list of content items; and
wherein providing, for display in the user interface of the content platform, the list of content items, comprises providing, for display in the user interface of the content platform, the second list of content items and the list of content items.

19. A system comprising:
at least one memory storing instructions; and
at least one hardware processor interoperably coupled with the at least one memory, wherein execution of the instructions by the at least one hardware processor causes performance of operations comprising:
determining, based on user activity data, that a first user of a first platform has interacted with content of a content platform during a particular timeframe;
identifying a first set of content items with which the first user has interacted during the particular timeframe;
comparing a first dataset representing text in the first set of content items with a second dataset representing text in other content items with which other users of the first platform have interacted during the particular timeframe;
identifying, based on comparing the first dataset and the second dataset, a list of content items that are similar to the first set of content items represented in the first dataset; and
providing, for display in a user interface of the content platform, the list of content items.

20. The system of claim 19, wherein comparing the first dataset representing text in the first set of content items with the second dataset representing text in other content items with which other users of the first platform have interacted during the particular timeframe, comprises:
generating the first dataset by numerically representing the text in the first set of content items;
generating the second dataset by numerically representing the text in the other content items; and
comparing, using a word-mover distance algorithm, the first dataset and the second dataset.

21. The system of claim 19, wherein the operations further comprise:
obtaining, from a user account repository stored on the first platform, first attribute data corresponding to the first user;
inputting the first attribute data into a trained model, wherein the trained model is trained using attribute data for a plurality of users of the first platform and corresponding content preference data for the plurality of users;
obtaining, using an output generated by the trained model in response to the input first attribute data, data identifying a set of users of the first platform who are expected to have similar content preferences as the first user;
generating, using content with which the set of users has interacted, a second list of content items; and
wherein providing, for display in the user interface of the content platform, the list of content items, comprises providing, for display in the user interface of the content platform, the second list of content items and the list of content items.

22. A non-transitory, computer-readable medium storing computer-readable instructions, that upon execution by at least one hardware processor, cause performance of operations, comprising:
determining, based on user activity data, that a first user of a first platform has interacted with content of a content platform during a particular timeframe;
identifying a first set of content items with which the first user has interacted during the particular timeframe;
comparing a first dataset representing text in the first set of content items with a second dataset representing text in other content items with which other users of the first platform have interacted during the particular timeframe;
identifying, based on comparing the first dataset and the second dataset, a list of content items that are similar to the first set of content items represented in the first dataset; and
providing, for display in a user interface of the content platform, the list of content items.

23. The non-transitory, computer-readable medium of claim 22, wherein comparing the first dataset representing text in the first set of content items with the second dataset representing text in other content items with which other users of the first platform have interacted during the particular timeframe, comprises:
generating the first dataset by numerically representing the text in the first set of content items;
generating the second dataset by numerically representing the text in the other content items; and
comparing, using a word-mover distance algorithm, the first dataset and the second dataset.

24. The non-transitory, computer-readable medium of claim 22, wherein the operations further comprise:
obtaining, from a user account repository stored on the first platform, first attribute data corresponding to the first user;
inputting the first attribute data into a trained model, wherein the trained model is trained using attribute data for a plurality of users of the first platform and corresponding content preference data for the plurality of users;
obtaining, using an output generated by the trained model in response to the input first attribute data, data identifying a set of users of the first platform who are expected to have similar content preferences as the first user;
generating, using content with which the set of users has interacted, a second list of content items; and
wherein providing, for display in the user interface of the content platform, the list of content items, comprises providing, for display in the user interface of the content platform, the second list of content items and the list of content items.
